(19) United States
(12) Patent Application Publication
(10) Pub. No.: US 2024/0359725 A1
(43) Pub. Date: Oct. 31, 2024

(54) HAND WHEEL ACTUATOR ASSEMBLY WITH INTEGRATED BELT DRIVE

(71) Applicant: Steering Solutions IP Holding Corporation, Saginaw, MI (US)

(72) Inventors: Steven J. Collier-Hallman, Frankenmuth, MI (US); Laura F. Stock, Auburn, MI (US); Todd F. Jammer, Birch Run, MI (US); Joel A. Bickel, Millington, MI (US)

(21) Appl. No.: 18/647,946

(22) Filed: Apr. 26, 2024

Related U.S. Application Data
(60) Provisional application No. 63/462,476, filed on Apr. 27, 2023.

(51) Int. Cl. B62D 5/00; F16H 7/08; F16H 7/12

(52) U.S. Cl. CPC B62D 5/006; F16H 7/12; F16H 2007/0865; F16H 2007/0897

(57) ABSTRACT

A hand wheel actuator assembly, the hand wheel actuator assembly includes a motor. The hand wheel actuator assembly also includes a motor shaft coaxially aligned with a motor axis, the motor shaft rotatably coupled to the motor, and the motor configured to cause rotation of the motor shaft about the motor axis. The hand wheel actuator assembly further includes a hand wheel shaft coaxially aligned with a hand wheel axis, the hand wheel shaft spaced from and parallel to the motor shaft, wherein the motor shaft is coupled to the hand wheel shaft by a belt. The hand wheel actuator assembly yet further includes a circuit board located between the belt and the motor.

### CROSS-REFERENCE TO RELATED APPLICATION

This application claims the benefits of priority to U.S. Provisional Patent Application Ser. No. 63/462,476, filed Apr. 27, 2023, the disclosure of which is incorporated by reference herein in its entirety.

### TECHNICAL FIELD

The following description relates to a hand wheel actuator assembly with an integrated belt drive and controller for a vehicle steering system.

### BACKGROUND

As technology advances in the automobile industry, direct mechanical linkages between the steering wheel and tires are being replaced with a HWA and road-wheel actuator (RWA), which may be part of steering systems referred to as “steer-by-wire” systems. During travel of the automobile, the HWA and RWA cooperate with one another, through electrical communication (e.g., wires, sensors, and a central processing unit), to control travel of the automobile. More specifically, sensed movement of the respective hand wheel and/or tires is electrically communicated to the respective HWA or RWA to cause movement of the hand wheel and/or tires as feedback to a driver.

Steer-by-wire systems require a HWA to provide hand wheel position information to the RWA and torque feedback to the driver. The space under the dashboard in the vehicle is often constrained and imposes stringent packaging requirements. Additionally, steer-by-wire systems typically have higher bill of material cost compared to conventional steering systems due to the addition of the second actuator. This higher cost and the desire to have excellent steering feel renders elimination of the torque sensor advantageous.

### SUMMARY OF THE DISCLOSURE

According to one aspect of the disclosure, a hand wheel actuator assembly, the hand wheel actuator assembly includes a motor. The hand wheel actuator assembly also includes a motor shaft coaxially aligned with a motor axis, the motor shaft rotatably coupled to the motor, and the motor configured to cause rotation of the motor shaft about the motor axis. The hand wheel actuator assembly further includes a hand wheel shaft coaxially aligned with a hand wheel axis, the hand wheel shaft spaced from and parallel to the motor shaft, wherein the motor shaft is coupled to the hand wheel shaft by a belt. The hand wheel actuator assembly yet further includes a circuit board located between the belt and the motor.

According to another aspect of the disclosure, a hand wheel actuator assembly includes a motor. The hand wheel actuator assembly also includes a motor shaft coaxially aligned with a motor axis, the motor shaft rotatably coupled to the motor, and the motor configured to cause rotation of the motor shaft about the motor axis. The hand wheel actuator assembly further includes a hand wheel shaft coaxially aligned with a hand wheel axis, the hand wheel shaft spaced from and parallel to the motor shaft. The hand wheel actuator assembly yet further includes a belt drive assembly. The belt drive assembly includes a drive pulley disposed proximate an end of the motor shaft distal from the motor. The belt drive assembly also includes a driven pulley operatively coupled to the hand wheel shaft. The belt drive assembly further includes a belt in contact with the drive pulley and the driven pulley to rotatably couple the motor shaft and the hand wheel shaft. The belt drive assembly yet further includes a pair of idler pulleys which may be adjusted by an adjustment device to adjust the tension between the motor shaft and the hand wheel shaft.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an elevation view of a hand wheel actuator assembly;

FIG. 2 is a cross-sectional view of the hand wheel actuator assembly;

FIG. 3 is an elevation view of the hand wheel actuator assembly illustrating a column position sensor according to one aspect of the disclosure;

FIG. 4 is a cross-sectional view of the hand wheel actuator assembly illustrating a column position sensor according to another aspect of the disclosure;

FIG. 5 is a cross-sectional view of the hand wheel actuator assembly illustrating a column position sensor according to another aspect of the disclosure;

FIG. 6 is a perspective view of the hand wheel actuator assembly having a pivoting cap with idler pulleys attached thereto;

FIG. 7 is a perspective, partially transparent view of the hand wheel actuator assembly with the pivoting cap of FIG. 6;

FIG. 8 is a perspective view of the pivoting cap of FIGS. 6 and 7;

FIG. 9 is a perspective view of the hand wheel actuator assembly having a sliding cap with idler pulleys attached thereto;

FIG. 10 is a perspective, partially transparent view of the hand wheel actuator assembly with the sliding cap of FIG. 9;

FIG. 11 is a perspective view of the sliding cap of FIGS. 9 and 10;

FIG. 12 is a perspective view of a sliding cap with a pivoting ring and idler pulleys attached thereto;

FIG. 13 is a perspective view of the hand wheel actuator assembly with the sliding cap of FIG. 12;

FIG. 14 is a first side perspective view of the hand wheel actuator assembly according to another aspect of the disclosure;

FIG. 15 is a second side perspective view of the hand wheel actuator assembly of FIG. 14; and

FIG. 16 is a perspective, partially disassembled view of the hand wheel actuator assembly of FIGS. 14 and 15.

### DETAILED DESCRIPTION

The following discussion is directed to various embodiments of the disclosure. The embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

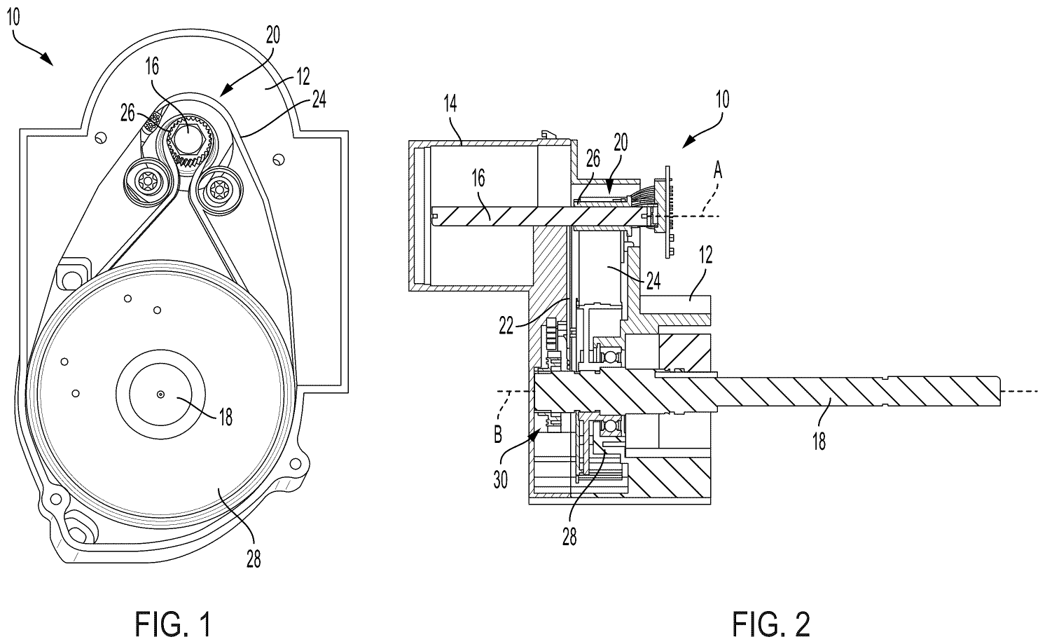

Referring to FIGS. 1-3, a hand wheel actuator (HWA) assembly 10 with an integrated belt drive and controller for a vehicle steering system is illustrated according to one aspect of the disclosure. As described herein, the HWA assembly 10 is utilized within a steer-by-wire steering system. The HWA assembly 10 comprises a housing 12 and a motor 14 coupled to the housing 12. Alternatively, the motor 14 may be disposed within, and coupled to, the housing 12. The HWA assembly 10 comprises a motor shaft 16 at least partially disposed in the housing 12 and that coaxially aligns with, and rotates about, a motor axis A. The motor shaft 16 rotatably couples to the motor 14, and the motor is configured to rotate the motor shaft 16 about the motor axis A.

The HWA assembly 10 further comprises a hand wheel shaft 18 at least partially disposed in, and rotatably coupled to, the housing 12. Alternatively, the hand wheel shaft 18 may rotatably couple to an element outside the housing 12, and extend into the housing 12 to be partially disposed in the housing 12. The hand wheel shaft 18 coaxially aligns with, and rotates about, a hand wheel axis B. Further, the hand wheel shaft 18 is spaced from, and substantially parallel to, the motor shaft 16.

In certain embodiments, a hand wheel couples to, and rotates with, the hand wheel shaft 18. The hand wheel may be any type of steering input device. It is to be appreciated, angular rotation of the hand wheel corresponds directly, and proportionally, to angular rotation of the hand wheel shaft 18. Correspondingly, angular rotation of the hand wheel shaft 18 corresponds directly, and proportionally, to angular rotation of the hand wheel. The motor shaft 16 couples to the hand wheel shaft 18 via a belt drive assembly 20 to cause rotation of the hand wheel shaft 18, and in turn, the hand wheel, when the motor 14 rotates the motor shaft 16 rotates. Accordingly, angular rotation of the hand wheel, hand wheel shaft 18 and motor shaft 16 are directly related, and proportional to one another. Further, the coupling between the motor 14 and hand wheel shaft 16 provides a ratio between the rotational rate of the respective motor and hand wheel shaft.

The HWA assembly 10 includes a printed circuit board 22. Further, a processor may couple to, or be integral with, the circuit board 22, and the processor. The motor shaft 16 couples to the hand wheel shaft 18 by a belt 24 which is part of the belt drive assembly 20. A drive pulley 26 couples to the motor shaft 16 adjacent an end of the motor shaft 16. The drive pulley 26 may include teeth in some embodiments. Alternatively, the drive pulley 26 may be integral with the motor shaft 16. A driven pulley 28 couples to the hand wheel shaft 18 adjacent an end of the hand wheel shaft 18 and may include teeth in some embodiments. Alternatively, the driven pulley 28 may be integral with the hand wheel shaft 18, and may also include teeth. Further, the belt 24 couples to, and causes relative rotation between, the drive and driven pulleys 26, 28 and, in turn, the motor and hand wheel shafts 16, 18. In this embodiment, the coupling by the belt 24 between the drive pulley 26 and driven pulley 28 provides the ratio between the rotational rate of the respective motor shaft 16 and hand wheel shaft 18. The belt 24 provides the benefit of being easily adjusted, which may alter the ratio.

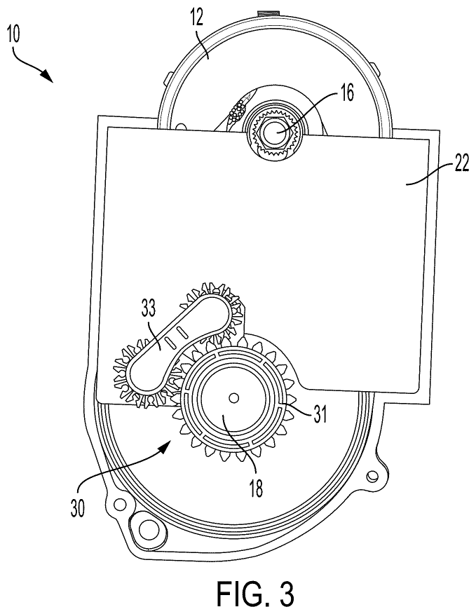

The motor axis A is parallel to the hand wheel axis B and the controller circuit board 22 is parallel to the belt 24 and on the side of the belt 24 closest to the motor 14. This allows for the motor phase leads to be directly connected to the motor 14. Also, since the drive pulley 26 is smaller in diameter than the driven pulley 28, the available circuit board space is largest in that area without unnecessarily enlarging the area around the belt drive assembly 20. The belt 24 and pulleys 26, 28 may be in the same housing 12 as the circuit board 22, or the housing 12 may be divided such that the belt 24 and pulleys 26, 28 are separated from the circuit board 22. A position sensor 30 is placed on the circuit board 22 near the hand wheel actuator axis B. This saves interconnect cost and complexity compared to the controller being conventionally located on the opposite end of the motor shaft 16. The position sensor 30 may be an off-axis sensor mounted on the board 22. For example, as shown in FIG. 3, the sensor 30 may include a toothed gear 31 mounted to the hand wheel shaft 18 and a gear sensor 33 mounted to the circuit board 22. Alternatively, the position sensor 30 may be located on the side of the belt 24 opposite the controller circuit board 22 and at the end of the motor shaft 16. This simplifies the sensor design. As an additional alternative, the position sensor 30 may be mounted at the opposite end of the motor 14. This simplifies the sensor design as well.

The embodiments disclosed places the circuit board 22 between the belt 24 and the motor 14 compared to prior designs where the circuit board 22 is between the housing 12 and the end of the motor shaft 16 distal from the motor 14. This simplifies the motor phase connection to the circuit board 22 and makes more efficient use of the available space.

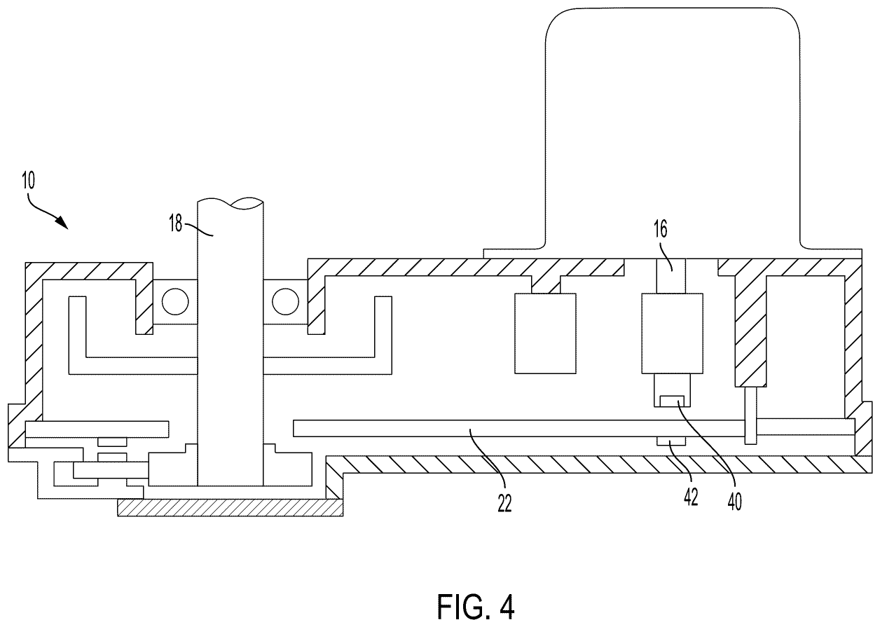

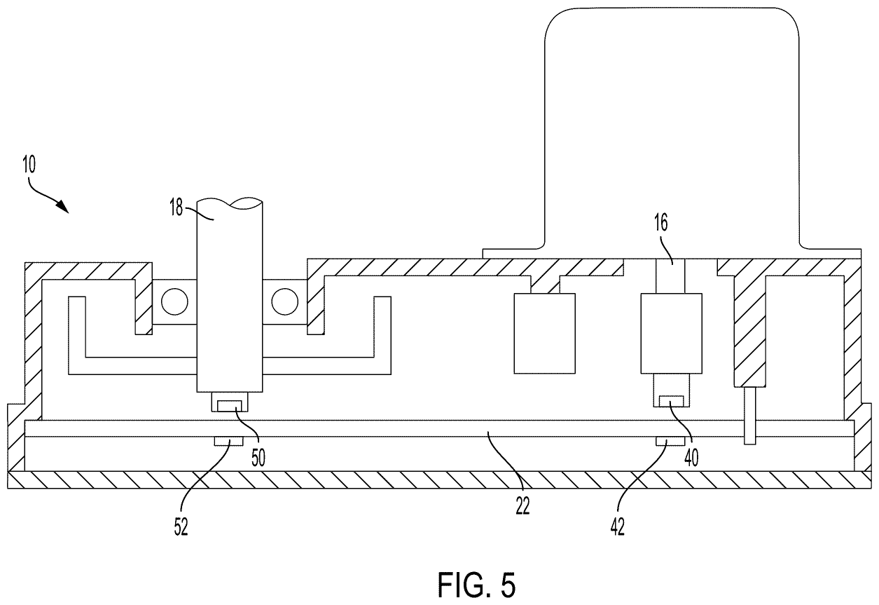

FIGS. 4 and 5 illustrate other embodiments of the HWA assembly 10. For example, in the embodiment shown in FIG. 4, the circuit board 22 is between a magnet 40 at the end of the motor shaft 16 and a sensor 42, with the hand wheel shaft 18 extending through the circuit board 22. FIG. 5 illustrates the HWA assembly 10 with the circuit board 22 being between the magnet 40 and sensor 42, while also between a magnet 50 attached to the end of the hand wheel shaft 18 and a second sensor 52.

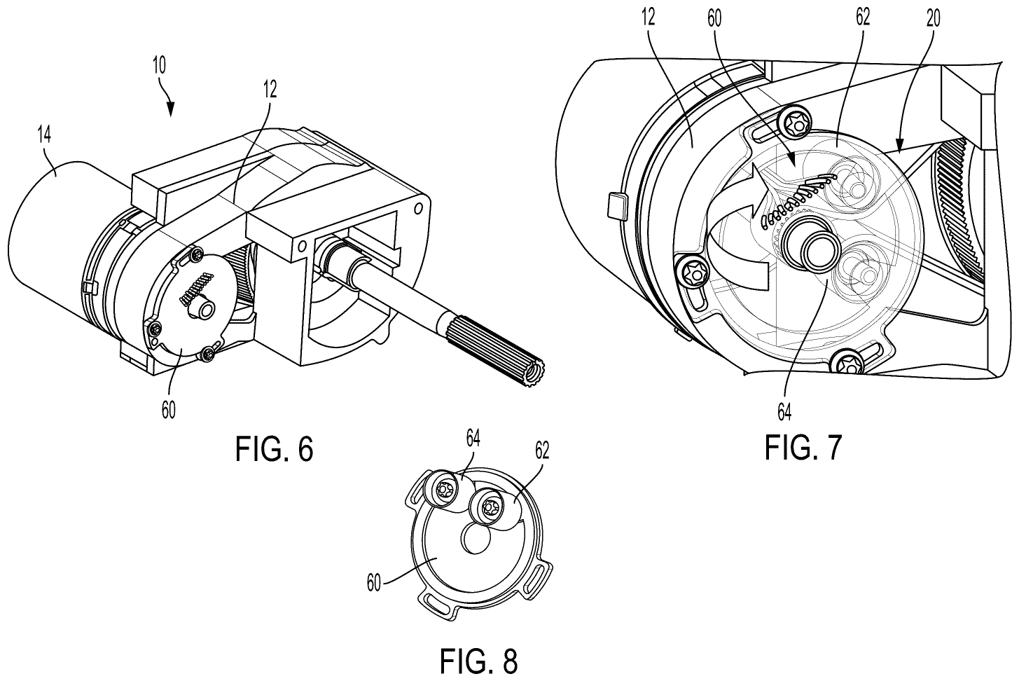

Referring now to FIGS. 6-8, the HWA assembly 10 is shown according to another aspect of the disclosure. In the illustrated embodiment, the HWA assembly 10 includes a pivoting cap 60 on one side of the housing 12 proximate an end of the motor shaft 16. The pivoting cap 60 can be pivoted to rotate idler pulleys 62, 64 of the belt drive assembly 20 with the pivoting cap 60 to set the tension of the belt 24. If rotated in one direction, the top idler 62 increases tension more than the lower idler 64 decreases tension, thereby resulting in a net tension increase.

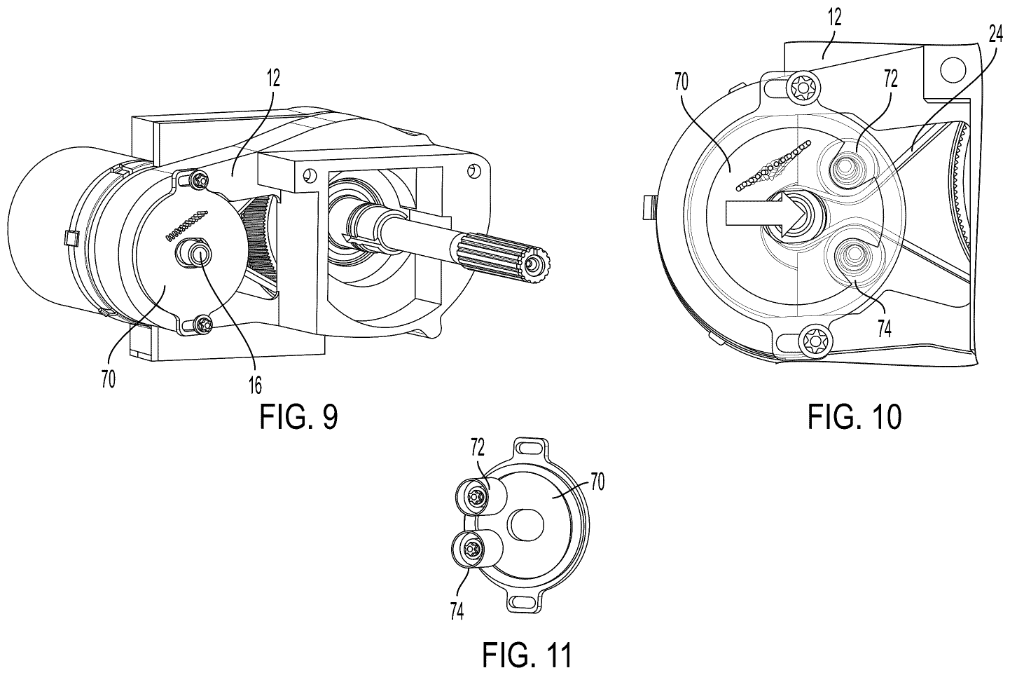

Referring now to FIGS. 9-11, the HWA assembly 10 is shown according to another aspect of the disclosure. In the illustrated embodiment the HWA assembly 10 includes a sliding cap 70 on one side of the housing 12 proximate an end of the motor shaft 16. The sliding cap 70 may be slid to set the tension and/or friction of the belt 24 by adjusting a pair of idler pulleys 72, 74.

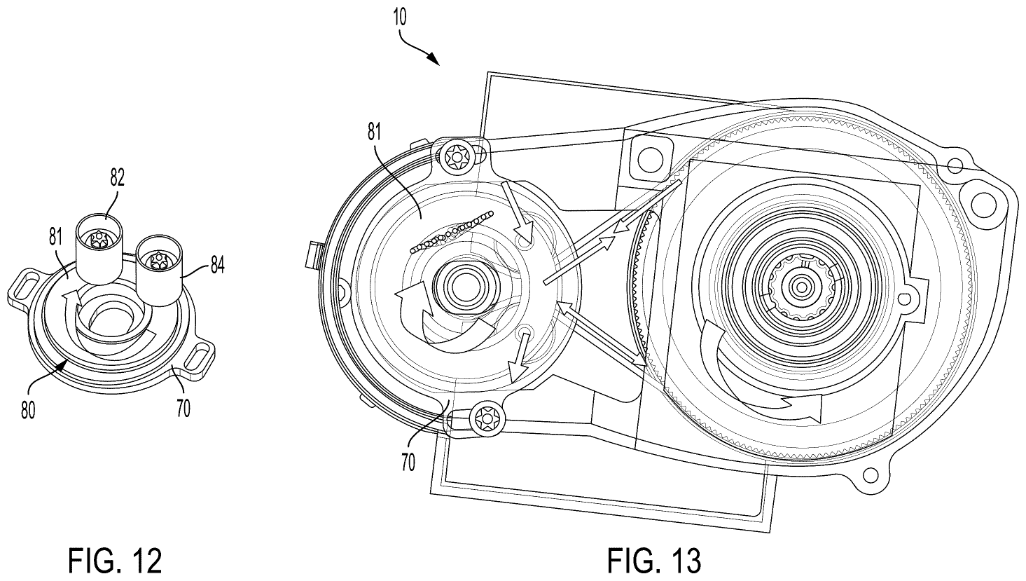

Referring now to FIGS. 12 and 13, the HWA assembly 10 is shown according to another aspect of the disclosure. In the illustrated embodiment the HWA assembly 10 includes a sliding cap 70 with active tensioning on one side of the housing 12 proximate an end of the motor shaft 16. The HWA assembly 10 includes an idler assembly 80 which pivots on the sliding cap 70 during tension adjustment. The idler assembly 80 includes a disk coupled to the sliding cap 70 and a pair of idler pulleys 82, 84.

The caps 60, 70 and associated components of FIGS. 6-13 may be generically referred to as an adjustment device herein.

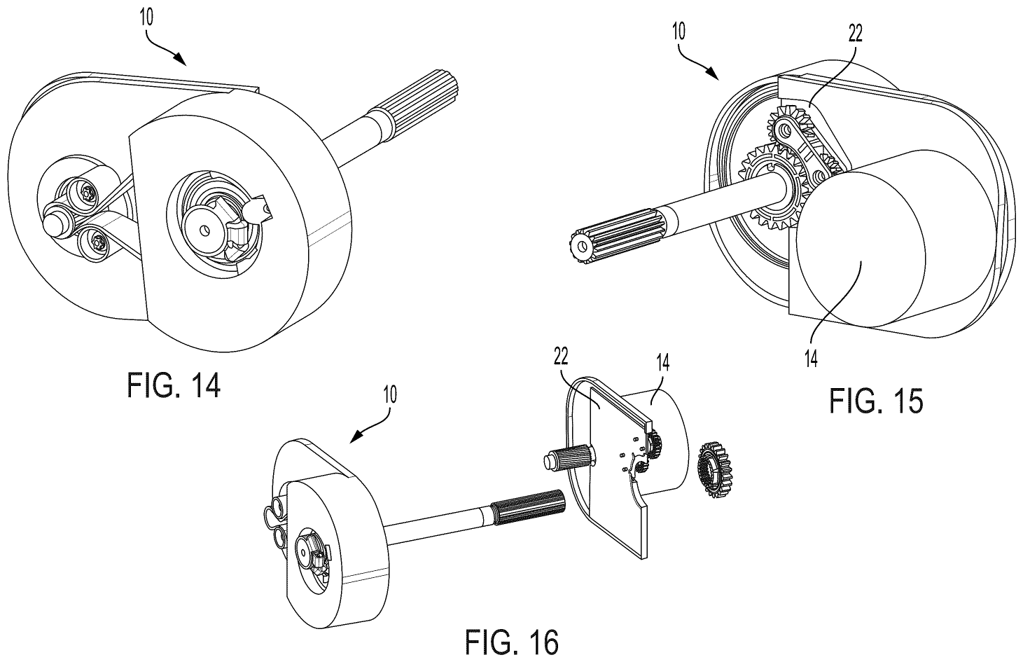

Referring now to FIGS. 14-16, the HWA assembly 10 is shown according to another aspect of the disclosure. The motor 14 and controller 22 can be pre-assembled and then installed to the HWA assembly 10 together as a single, integrally formed assembly.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A hand wheel actuator assembly, the hand wheel actuator assembly comprising:
a motor;
a motor shaft coaxially aligned with a motor axis, the motor shaft rotatably coupled to the motor, and the motor configured to cause rotation of the motor shaft about the motor axis;
a hand wheel shaft coaxially aligned with a hand wheel axis, the hand wheel shaft spaced from and parallel to the motor shaft, wherein the motor shaft is coupled to the hand wheel shaft by a belt; and
a circuit board located between the belt and the motor.

2. The hand wheel actuator assembly of claim 1, wherein the belt is part of a belt drive assembly comprising:
a drive pulley disposed proximate an end of the motor shaft distal from the motor;
a driven pulley operatively coupled to the hand wheel shaft; and
the belt in contact with the drive pulley and the driven pulley to rotatably couple the motor shaft and the hand wheel shaft.

3. The hand wheel actuator assembly of claim 2, wherein the belt drive assembly further comprises a pair of idler pulleys which may be adjusted by an adjustment device to adjust the tension between the motor shaft and the hand wheel shaft.

4. The hand wheel actuator assembly of claim 3, wherein the adjustment device is a pivotable cap operatively coupled to the idler pulleys.

5. The hand wheel actuator assembly of claim 3, wherein the adjustment device is a sliding cap operatively coupled to the idler pulleys.

6. The hand wheel actuator assembly of claim 5, wherein the adjustment device includes an idler assembly coupled to the sliding cap.

7. The hand wheel actuator assembly of claim 1, further comprising a sensor on the opposite side of the circuit board relative to a magnet on the motor shaft and a magnet on the hand wheel shaft.

8. The hand wheel actuator assembly of claim 7, wherein the sensor comprises a rotatable toothed gear coupled to the hand wheel shaft.

9. The hand wheel actuator assembly of claim 8, wherein the sensor further comprises a gear sensor coupled to the circuit board.

10. A hand wheel actuator assembly, the hand wheel actuator assembly comprising:
a motor;
a motor shaft coaxially aligned with a motor axis, the motor shaft rotatably coupled to the motor, and the motor configured to cause rotation of the motor shaft about the motor axis;
a hand wheel shaft coaxially aligned with a hand wheel axis, the hand wheel shaft spaced from and parallel to the motor shaft; and
a belt drive assembly comprising:
a drive pulley disposed proximate an end of the motor shaft distal from the motor;
a driven pulley operatively coupled to the hand wheel shaft;
a belt in contact with the drive pulley and the driven pulley to rotatably couple the motor shaft and the hand wheel shaft; and
a pair of idler pulleys which may be adjusted by an adjustment device to adjust the tension between the motor shaft and the hand wheel shaft.

11. The hand wheel actuator assembly of claim 10, wherein the adjustment device is a pivotable cap operatively coupled to the idler pulleys.

12. The hand wheel actuator assembly of claim 10, wherein the adjustment device is a sliding cap operatively coupled to the idler pulleys.

13. The hand wheel actuator assembly of claim 10, wherein the adjustment device includes an idler assembly coupled to the sliding cap.

14. The hand wheel actuator assembly of claim 10, further comprising a sensor on the opposite side of the circuit board relative to a magnet on the motor shaft and a magnet on the hand wheel shaft.

15. The hand wheel actuator assembly of claim 10, further comprising a circuit board located between the belt and the motor.

16. The hand wheel actuator assembly of claim 15, wherein the sensor comprises a rotatable toothed gear coupled to the hand wheel shaft.

17. The hand wheel actuator assembly of claim 16, wherein the sensor further comprises a gear sensor coupled to the circuit board.
